(19) United States
(12) Patent Application Publication
(10) Pub. No.: US 2015/0377461 A1
(43) Pub. Date: Dec. 31, 2015

(54) Decorative LED Lighting System

(71) Applicants: Lexington Lighting Group, LLC dba Wilshire Manufacturing, Taunton, MA (US); Fusion Optix, Inc., Woburn, MA (US)

(72) Inventors: Matthew Jon Hutchins, Westwood, MA (US); Timothy Kelly, Brookline, MA (US); Mark E. Segill, Framingham, MA (US); Steven B. Kaufman, Lexington, MA (US); Terence Yeo, Boston, MA (US); David Morin, Milford, NH (US)

(21) Appl. No.: 14/747,159

(22) Filed: Jun. 23, 2015

Related U.S. Application Data
(60) Provisional application No. 62/016,687, filed on Jun. 25, 2014.
(60) Provisional application No. 62/090,865, filed on Dec. 11, 2014.

(51) Int. Cl. F21V 21/03; F21V 23/00; H05B 33/08; F21V 29/70

(52) U.S. Cl. CPC F21V 21/03; F21V 29/70; F21V 23/003; H05B 33/0845; H05B 33/0857; F21Y 2101/02

(57) ABSTRACT

The present disclosure generally provides for systems and methods that allow for LEDs to be effectively incorporated into existing lighting fixtures, including chandeliers and sconces. In some exemplary embodiments, the light source itself can include a heat sink disposed within a sleeve, a base disposed at the bottom of the sleeve and conductively coupled with the heat sink, an LED component disposed on the top of the heat sink, and one or more optical distributors associated with either or both of the heat sink and sleeve. For example, there can be both an inner and optical distributor, with at least the outer distributor being removable and replaceable. The present disclosure enables LEDs to perform effectively in lighting fixtures such as chandeliers where such performance was previously not achievable. Additionally, the present disclosure provides for ways to retrofit existing lighting fixtures having incandescent lights with LED modules.

### CROSS REFERENCE TO RELATED APPLICATIONS

The present disclosure claims priority to U.S. Provisional Application No. 62/016,687, entitled “LED Chandelier System,” which was filed on Jun. 25, 2014, and to U.S. Provisional Application No. 62/090,865, entitled “LED Chandelier System,” which was filed on Dec. 11, 2014, each of which is hereby incorporated by reference in its entirety.

### BACKGROUND

LED lighting is being adopted in many lighting applications due to a variety of benefits as compared to conventional incandescent and discharge lighting products. Typical primary benefits of LED lighting include increased energy efficiency and longer product life. Despite these advantages, adoption is slowed by the need for greater lumen output LED devices and the thermal management and electrical control requirements of LED light sources. A number of other key optical characteristics such as color temperature, color rendering, angular light distribution, peak brightness, glare, and spatial brightness uniformity are similarly important with LED light sources but must be achieved using different technologies, materials, and engineering and fabrication processes than conventional incandescent and discharge lighting products, all while preferably maintaining an appealing aesthetic. To date, decorative lighting products have struggled to sufficiently optimize all of these factors at reasonable cost and with an attractive design. Decorative lighting is an application where current existing LED lighting and retrofit solutions have fallen short in achieving desirable aesthetics and sufficient optimization of targets for interdependent key characteristics over life such as lumen output, color temperature, color rendering, light distribution, peak brightness, glare, spatial brightness uniformity. Therefore, opportunity exists for an improved LED decorative lighting system.

FIG. 1 (Prior Art) is an illustration of an incandescent lamp chandelier with candle assemblies. A candle assembly 41 is further comprised of a candle shaft 42 and drip pan 43. An incandescent filament 45 is positioned within a bulb 44.

FIG. 2 (Prior Art) is an LED candelabra bulb typical of those currently used for LED chandelier lighting solutions. The screw base 51 of the bulb allows it to screw into the same standard candelabra bases as incandescent candelabra lamps. The LED candelabra bulb contains a housing 52 which contains a driver and LED light source 50. The large size and location of the housing 52 causes multiple negative effects which lead to sub-optimal system performance. Firstly, the candle aesthetic is degraded by the large bulbous shape and white heat sink which is not the same form factor or finish as a typically desirable sleeve (e.g., brass) and traditional decorative bulb. Secondly, positioning two heat generating devices, e.g., the LED light source and driver, within an enclosed cavity leads to overheating and low maximum LED power that can be applied, as well as reliability issues due to prolonged heating of electronic components. These thermal challenges also significantly limit peak lumen output to a level substantially below standard 40 W and 60 W incandescent candelabra bulb lumen outputs, as well as limit the color range of output light, which makes the light less aesthetically pleasing. For example, the lamp of FIG. 2 is only rated for 150 lumens with a lower color level of 80 CRI, but a 60 W incandescent bulb should achieve 500+ lumens with full color approaching 99 CRI. The optic 53 is housed within the outer bulb 54 and is a tube shape with an inverted cone shape indentation at the tip.

### SUMMARY

As disclosed in the present application, improved performance in LED decorative lighting systems, including but not limited to chandeliers and sconces, is obtained by the use of a centralized electrical controller and a network of distributed LED or light-emitting modules or candle light assemblies mounted to a housing or frame, for instance by way of a connecting arm. Also disclosed are novel interface components to facilitate connection of the electrical controller with multiple network pathways. Additionally, some disclosed LED decorative lighting embodiments use light scattering crystals which, in combination with specifically configured LED light sources, can provide lighting effects not possible with typical lighting systems. Furthermore, novel and useful LED or light-emitting modules, which can include candle assemblies, are provided. The modules can be used as light sources for the chandelier, sconce, or other decorative lighting systems known to those skilled in the art.

In one exemplary embodiment of a lighting fixture, the fixture includes a housing, an LED driver disposed within the housing, a light-emitting module, and a connecting arm extending between the housing and the light-emitting module. Further, the light-emitting module includes an elongate sleeve with a heat sink disposed in the sleeve, an LED component, and at least one optical distributor. The LED component can be configured to produce light by way of one or more LEDs associated with the component, and the component can be coupled to a top end of the heat sink. At least one optical distributor(s) is disposed above the LED component and above at least a portion of the sleeve. Further, the optical distributor(s) is coupled to at least one of the heat sink and the sleeve. The heat sink can be conductively coupled to the housing such that heat generated by the LED component can dissipate through the heat sink and through the housing. Still further, the connecting arm includes a conduit having a wire disposed in it, the wire electrically coupling the LED driver to the light-emitting module such that the LED driver provides electrical current to produce light by way of the one or more LEDs.

In some embodiments, the elongate sleeve can have a diameter that is approximately in the range of about 0.5 inches to about 1.75 inches. A person skilled in the art will recognize that a sleeve having a small size typically results in a small-sized light source, such as a candelabra bulb, and thus in the present disclosure it typically results in a smaller LED. Despite a small-sized LED, however, a lumen output produced by the one or more LEDs can be, in some instances, approximately in the range of about 200 lumens to about 2000 lumens. Further, a color rendering index of light produced by the one or more LEDs can be approximately in the range of about 80 to about 99 in that size and lumen output range. Still further, in some embodiments a gamut area index of light produced by the one or more LEDs for that size, lumen output range, and color rendering index of light can be approximately in the range of about 60 to about 100.

For a fixture having the aforementioned sleeve size and lumen output, in some embodiments a color temperature produced by the one or more LEDs can be approximately in the range of about 2200 Kelvin to about 5000 Kelvin. Further, for a fixture having the aforementioned sleeve size and lumen output, the lumen output produced by the one or more LEDs can be configured in a manner that as the lumen output is lowered, for instance by dimming the light output from about 100 percent to about 0.1 percent, a color temperature produced by the one or more LEDs can go from approximately 3000 Kelvin to about 2200 Kelvin. Notably, these parameters (e.g., lumen output, color rendering index of light, gamut area index, and color temperature) and others known to or otherwise derivable by those skilled in the art can be achieved across other designs of lighting fixtures, light source assemblies, and light sources provided for in the present disclosure without one parameter necessarily having to be tied to another. For example, the indicated sizes of the sleeve, lumen output, color rendering index, gamut area index of light, and color temperatures provided above can, but do not have to, occur contemporaneously.

The optical distributor(s) can include both an outer optical distributor and an inner optical distributor that is disposed within the outer optical distributor. The outer optical distributor can be removably and replaceably coupled to at least one of the heat sink and the sleeve. The inner optical distributor can include a light scattering region that is configured to redirect light into a broad distribution pattern, towards the outer optical distributor. In some embodiments, the inner optical distributor can include a light guide that is disposed between the LED component and the light scattering region. The light guide can be configured to guide light from the one or more LEDs to the light scattering region.

The lighting fixture can include a plurality of light-emitting modules, each having a connecting arm associated with it to connect the light-emitting module to the housing. Such a configuration can result in the formation of a chandelier. Each connecting arm can have wire disposed within it that provides electrical current from the LED driver to one or more LEDs of each of the light-emitting modules to produce light from the one or more LEDs of the respective light-emitting modules.

In some embodiments, the housing of the lighting fixture can include a ceiling mount that allows the fixture to be mounted to a ceiling, a central hub disposed below the ceiling mount, and a stem disposed between the ceiling and the central hub. The connecting arms can couple to the housing at the central hub, and the stem can allow the central hub, the connecting arms, and the light-emitting modules to be disposed a distance away from a ceiling. The LED driver can be disposed in the central hub, or alternatively, it can be disposed in the stem. Still further, in some embodiments, the stem can include one or more ventilation slits formed in it. Alternatively, or additionally, the sleeve can include one or more ventilation slits formed in it.

The light-emitting module can include a conductive plate that is disposed between the heat sink and the connecting arm. In such an arrangement, the plate can conductively couple the heat sink to the connecting arm and to the housing. In some embodiments, the lighting fixture can also include an auxiliary electronic control that is coupled to the LED component. The auxiliary electronic control can be used to adjust a number of parameters, including but not limited to one or more of: a color of light produced by the one or more LEDs, and an intensity of light produced by the one or more LEDs.

In one exemplary embodiment of a light source assembly, the assembly includes a hollow sleeve, a heat sink, a base, an LED component, an outer optical distributor, and an inner optical distributor. The heat sink is disposed within the hollow sleeve, and the base is disposed at a bottom end of the sleeve, with the heat sink conductively coupled with the base. The LED component is disposed on top of the heat sink, with the LED component including one or more LEDs associated with it and that are configured to produce light. The outer optical distributor can be removably and replaceably coupled to at least one of the heat sink and the hollow sleeve. As a result, when the outer optical distributor is uncoupled from the heat sink and/or the hollow sleeve, another optical distributor can be coupled to at least one of the heat sink and the hollow sleeve in the same manner the first outer optical distributor was coupled to the heat sink and/or hollow sleeve. The inner optical distributor is disposed within the outer optical distributor and has a light scattering region configured to redirect light produced by the one or more LEDs into a broad distribution pattern, toward the outer optical distributor.

The outer optical distributor can include a body that has at least one opening formed in it through which light from the LED component passes. Alternatively, the outer optical body can include a body that covers any portion of a surrounding region disposed adjacent to the inner optical distributor through which light from the LED component passes. In some embodiments, the outer optical distributor can include crystal. The crystal can be faceted.

The hollow sleeve can have a diameter approximately in the range of about 0.5 inches to about 1.75 inches. A person skilled in the art will recognize that a sleeve having a small size typically results in a small-sized light source, such as a candelabra bulb, and thus in the present disclosure it typically results in a smaller LED. Despite a small-sized LED, however, a lumen output produced by the one or more LEDs can be, in some instances, approximately in the range of about 200 lumens to about 2000 lumens. Further, a color rendering index of light produced by the one or more LEDs can be approximately in the range of about 80 to about 99 in that size and lumen output range. Still further, in some embodiments a gamut area index of light produced by the one or more LEDs for that size, lumen output range, and color rendering index of light can be approximately in the range of about 60 to about 100.

For a fixture having the aforementioned sleeve size and lumen output, in some embodiments a color temperature produced by the one or more LEDs can be approximately in the range of about 2200 Kelvin to about 5000 Kelvin. Further, for a fixture having the aforementioned sleeve size and lumen output, the lumen output produced by the one or more LEDs can be configured in a manner that as the lumen output is lowered, for instance by dimming the light output from about 100 percent to about 0.1 percent, a color temperature produced by the one or more LEDs can go from approximately 3000 Kelvin to about 2200 Kelvin. Notably, these parameters (e.g., lumen output, color rendering index of light, gamut area index, and color temperature) and others known to or otherwise derivable by those skilled in the art can be achieved across other designs of lighting fixtures, light source assemblies, and light sources provided for in the present disclosure without one parameter necessarily having to be tied to another. For example, the indicated sizes of the sleeve, lumen output, color rendering index, gamut area index of light, and color temperatures provided above can, but do not have to, occur contemporaneously.

In some embodiments, an entirety of the heat sink can be disposed within the hollow sleeve. The light scattering region can include a matrix volume of a first optically transmissive material that has dispersed particles of a second optically transmissive material. The first and second optically transmissive materials can have different refractive indices. In some embodiments, the difference between the refractive indices of the first and second optically transmissive materials is approximately in the range of about 0.001 to about 0.03.

A second heat sink can also be provided. For example, a second heat sink can be disposed in the sleeve above the first heat sink, such as by having the second heat sink encircling portions of both the outer and inner optical distributors. In some embodiments, the hollow sleeve can include one or more ventilation slits formed in it. A width of the base can be larger than a diameter of the hollow sleeve. The light source assembly can also include an auxiliary electronic control that is coupled to the LED component. The control can be configured to adjust one or more parameters, such as a color of light produced by the one or more LEDs and an intensity of light produced by the one or more LEDs.

A number of methods are also disclosed, provided for, or are otherwise derivable from the present disclosures. One exemplary method for replacing a light source includes removing one or more existing incandescent sockets and line voltage associated with the sockets from a lighting fixture. The lightning fixture can include a housing, at least one existing incandescent light module disposed about the housing, and a connecting arm extending between each of the incandescent light modules and the housing. The incandescent light module can have a sleeve and an incandescent socket of the one or more existing incandescent sockets associated with the sleeve. After removing the socket(s) and line voltage, a heat sink having one or more LEDs coupled to it is coupled to the connecting arm at one or more locations of the lighting fixture at which the incandescent socket(s) were previous disposed. The heat sink is disposed in at least a portion of the sleeve. One or more direct current power lines that are electrically coupled to the one or more LEDs are disposed through a conduit of the connecting arm to a central wiring compartment of the housing, while an LED driver is disposed within the housing. The direct current power line(s) are electrically coupled to the LED driver, and the LED driver is electrically coupled to an electric mains power associated with the lighting fixture. An optical distributor can be coupled to at least one of the heat sink and the sleeve as desired.

In some embodiments, the optical distributor can include both an inner optical distributor and an outer optical distributor. In such embodiments, the action of coupling an optical distributor to the heat sink and/or sleeve can include coupling the inner optical distributor to the heat sink and coupling the outer optical distributor to the sleeve. Further, the optical distributor can be removable and replaceable. Thus, the outer optical distributor can subsequently be uncoupled from the sleeve and a second outer optical distributor can be coupled to the sleeve. The second optical distributor can provide any of a different shape, color, look, material, or other changes desired by a viewer.

In some embodiments, the light fixture is a chandelier. Heat generated by the light fixture and its components can dissipate through the heat sink, through the connecting arm, and through the housing due to the heat sink being conductively coupled to the housing by way of the connecting arm. The one or more LEDs can be configured to be dimmed to adjust an intensity of light produced by the one or more LEDs. Likewise, the one or more LEDs can be configured to be color adjusted to adjust a color of light produced by the one or more LEDs, either contemporaneously with or separate from the ability to dim the one or more LEDs.

The sleeve can have a diameter approximately in the range of about 0.5 inches to about 1.75 inches. A person skilled in the art will recognize that a sleeve having a small size typically results in a small-sized light source, such as a candelabra bulb, and thus in the present disclosure it typically results in a smaller LED. Despite a small-sized LED, however, a lumen output produced by the one or more LEDs can be, in some instances, approximately in the range of about 200 lumens to about 2000 lumens. Further, a color rendering index of light produced by the one or more LEDs can be approximately in the range of about 80 to about 99 in that size and lumen output range. Still further, in some embodiments a gamut area index of light produced by the one or more LEDs for that size, lumen output range, and color rendering index of light can be approximately in the range of about 60 to about 100.

For a light source having the aforementioned sleeve size and lumen output, in some embodiments a color temperature produced by the one or more LEDs can be approximately in the range of about 2200 Kelvin to about 5000 Kelvin. Further, for a light source having the aforementioned sleeve size and lumen output, the lumen output produced by the one or more LEDs can be configured in a manner that as the lumen output is lowered, for instance by dimming the light output from about 100 percent to about 0.1 percent, a color temperature produced by the one or more LEDs can go from approximately 3000 Kelvin to about 2200 Kelvin. Notably, these parameters (e.g., lumen output, color rendering index of light, gamut area index, and color temperature) and others known to or otherwise derivable by those skilled in the art can be achieved across other designs of lighting fixtures, light source assemblies, and light sources provided for in the present disclosure without one parameter necessarily having to be tied to another. For example, the indicated sizes of the sleeve, lumen output, color rendering index, gamut area index of light, and color temperatures provided above can, but do not have to, occur contemporaneously.

### BRIEF DESCRIPTION OF FIGURES

The accompanying drawings are not intended to be drawn to scale. In the drawings, at least in some instances, identical or nearly identical components are represented by a like numeral and/or a like name. A person skilled in the art will recognize that in some instances, however, identical or nearly identical components may not be like-numbered, or possibly even like-named, but are still similar and thus features from one embodiment can be utilized in features from another embodiment unless explicitly stated otherwise. For purposes of clarity, not every component may be labeled in every drawing. In the drawings:

FIG. 1 (Prior Art) is an illustration of an incandescent lamp chandelier with candle assembly;

FIG. 2 (Prior Art) is an illustration of an LED candelabra bulb typical of those currently used for LED chandelier lighting solutions;

FIG. 3 is a side view of one exemplary embodiment of an LED lighting system;

FIG. 4a is a partially transparent side view of the LED lighting system of FIG. 3 illustrating a central driver;

FIG. 4b is a side view of another exemplary embodiment of an LED lighting system, the system including a central ventilation system;

FIG. 5 is a cross-sectional view of another exemplary embodiment of an LED lighting system;

FIG. 6a is a cross-sectional view of one exemplary embodiment of a light-emitting module or candle assembly;

FIG. 6b is cross-sectional view of another exemplary embodiment of a light-emitting module or candle assembly;

FIG. 6c is a plot of measured light intensity vs. angle for an exemplary embodiment of a light-emitting module or candle assembly like the one illustrated in FIG. 6a;

FIG. 7 is a detailed, cross-sectional view of a portion of another exemplary embodiment of a light-emitting module or candle assembly;

FIG. 8 is a cross-sectional view of a larger portion of the light-emitting module or candle assembly of FIG. 7, illustrating air passages for use in an active air circulation system;

FIG. 9 is a cross-sectional view of an exemplary embodiment of a sleeve or candle shaft for use in conjunction with the light-emitting modules or candle assemblies provided for herein, the sleeve having a bin-pin connector for easy connect and disconnect;

FIG. 10 is a side view of one exemplary embodiment of an outer optical distributor of the light-emitting module or candle assembly of FIG. 7, illustrating a Bulb Shape Hollow Glass Envelope;

FIG. 11 is a side view of another exemplary embodiment of an outer optical distributor for use in conjunction with the light-emitting modules or candle assemblies provided for herein, illustrating a Hollow Glass Tube Envelope;

FIG. 12 is a side view of yet another exemplary embodiment of an outer optical distributor for use in conjunction with the light-emitting modules or candle assemblies provided for herein, illustrating a K-5 or K-9 grade cut solid crystal;

FIG. 13 is a side view of still another exemplary embodiment of an outer optical distributor for use in conjunction with the light-emitting modules or candle assemblies provided for herein, illustrating a hollow glass envelope with a closed end;

FIG. 14 is a cross-sectional view of the outer optical distributor of FIG. 13;

FIG. 15 is a side view of another exemplary embodiment of an outer optical distributor for use in conjunction with the light-emitting modules or candle assemblies provided for herein, illustrating a Flower Petal Light Guide/Diffuser;

FIG. 16 is a partially transparent side view of one exemplary embodiment of a light-emitting module or candle assembly associated with an LED lighting system, illustrating an LED bulb of the light-emitting module or candle assembly being positioned within an outer optical distributor having a light diffusing goblet shaped glass shade;

FIG. 17 is a partially transparent side view of another embodiment of a light-emitting module or candle assembly associated with an LED lighting system, illustrating an optical distributor on both ends of a sleeve;

FIG. 18a is a schematic cross-sectional view of yet another exemplary embodiment of a light-emitting module or candle assembly, illustrating one portion of one exemplary candle assembly process;

FIG. 18b is a schematic cross-sectional view of the light-emitting module or candle assembly of FIG. 18a, illustrating a second portion of the one exemplary candle assembly process in which the attachment of an optical distributor to at least one of a heat sink and a sleeve is completed; and

FIG. 18c is a side view of another exemplary embodiment of an outer optical distributor, the distributor including a groove for use in a twist-lock connection.

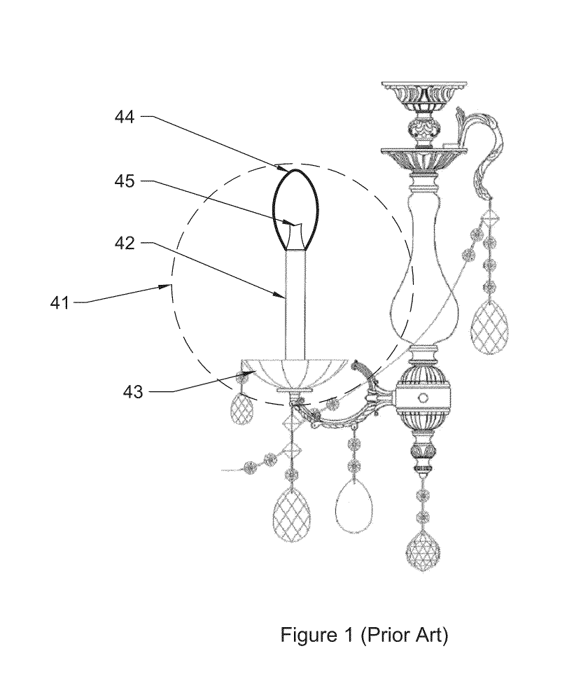

### DETAILED DESCRIPTION

This disclosure is not limited in its application to the details of construction and the arrangement of components set forth in the following description or illustrated in the drawings. The disclosed systems and methods are capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

The present description often makes reference to chandelier embodiments but a person skilled in the art will recognize a variety of other light sources in which the present disclosures can be effectively used, for example sconces. References to chandeliers is by no means limiting of the scope of the present disclosure and its applicability to the lighting industry as a whole.

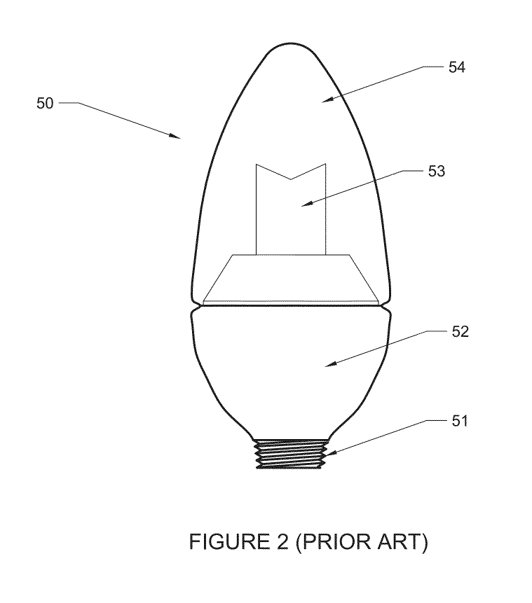

The presently disclosed lighting system is designed to provide an optimized quality of LED light integrated within a decorative lighting fixture (e.g., chandelier, sconce, and a variety of other lighting fixtures designs known to those skilled in the art), with an aesthetically pleasing fixture design, bulb design, and light quality. To accomplish this the thermal, electrical, and optical systems of the LED lighting system are located in separate sections of the fixture to optimize performance. This separation is different from the approach taken in conventional retrofit LED light bulbs 50, such as shown in FIG. 2, where the thermal, electrical, and optical elements are placed in close proximity. In existing LED light bulbs 50, the driver (not shown) is located within the housing 52, which is adjacent to and between a heat generating LED (not shown), which is also disposed in the housing 52, and a thermally conducting base 51. Furthermore, the base 51 typically screws into a ceramic socket of low thermal conductivity. The conventional retrofit LED bulb 50 limits the amount of light and the range of color that the bulb can produce due to challenges managing heat dissipation. It also affects the reliability and performance of the electrical system as the system has to also be small, local to the bulb, and subjected to high heat conditions resulting from its proximity to the other portions of the system (i.e., the thermal and optical systems). This sustained heat can result in damage to components, such as degrading the LED component or electronics, and/or cause component failure or malfunction such as bulb flicker.

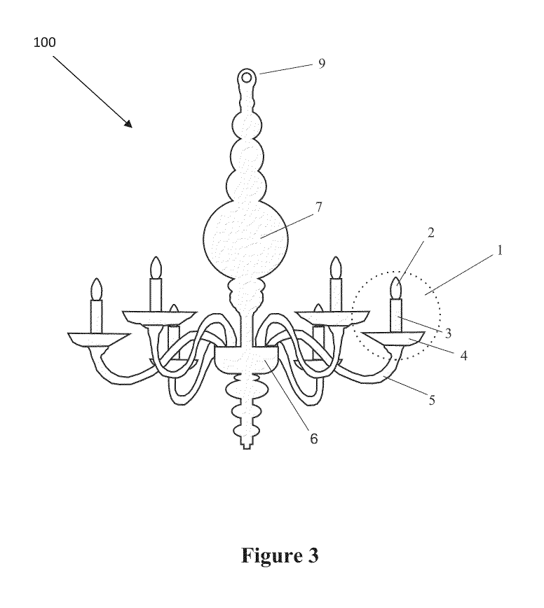

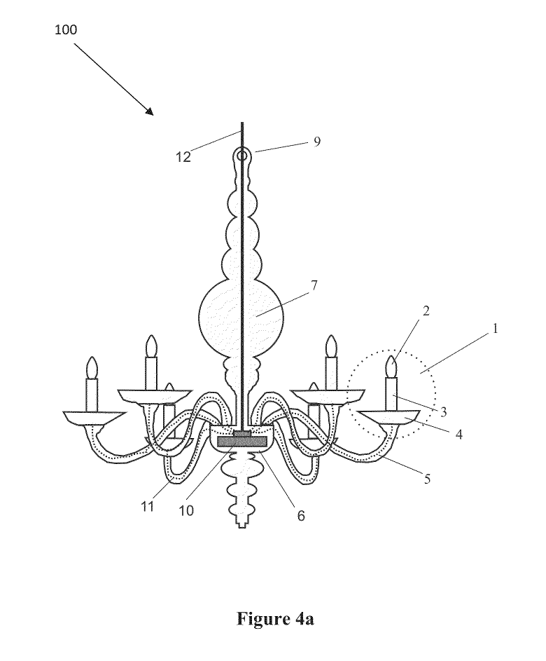

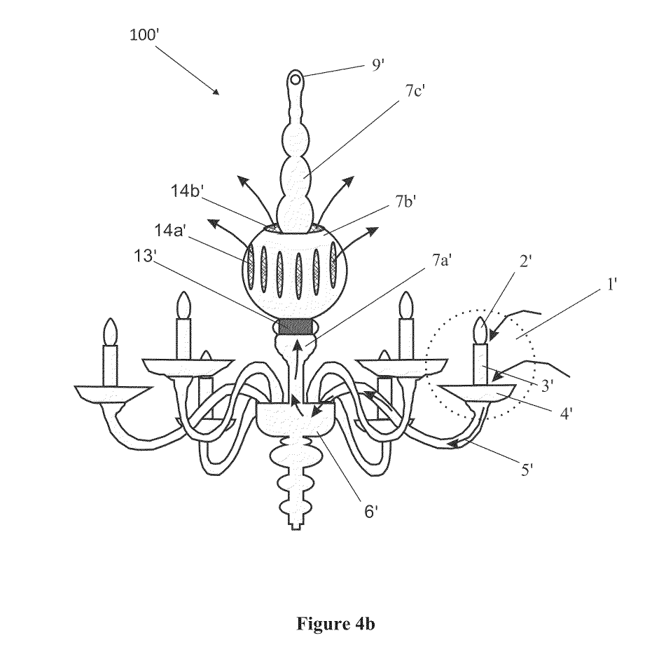

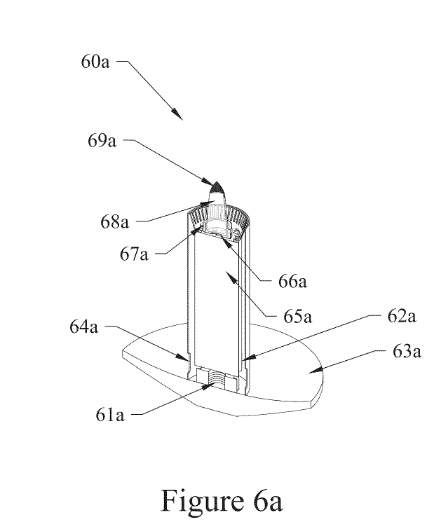

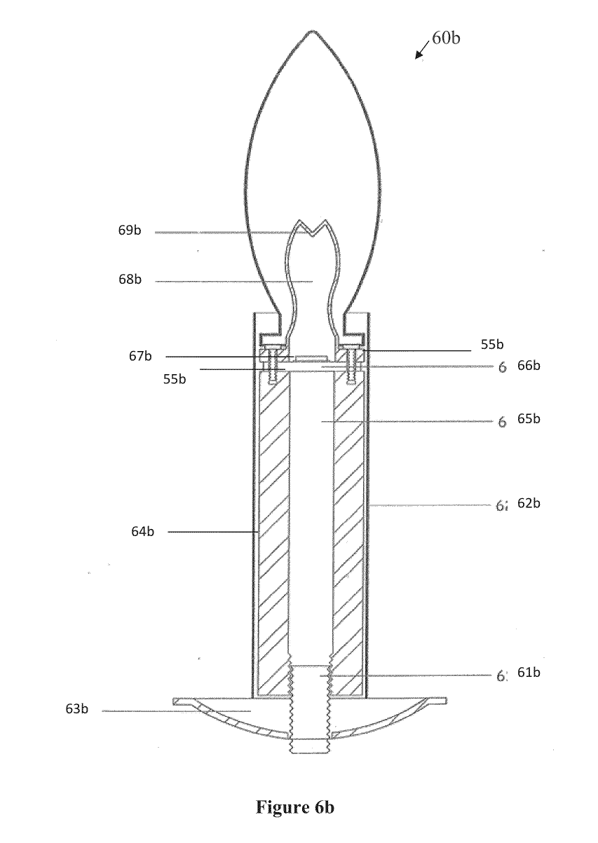

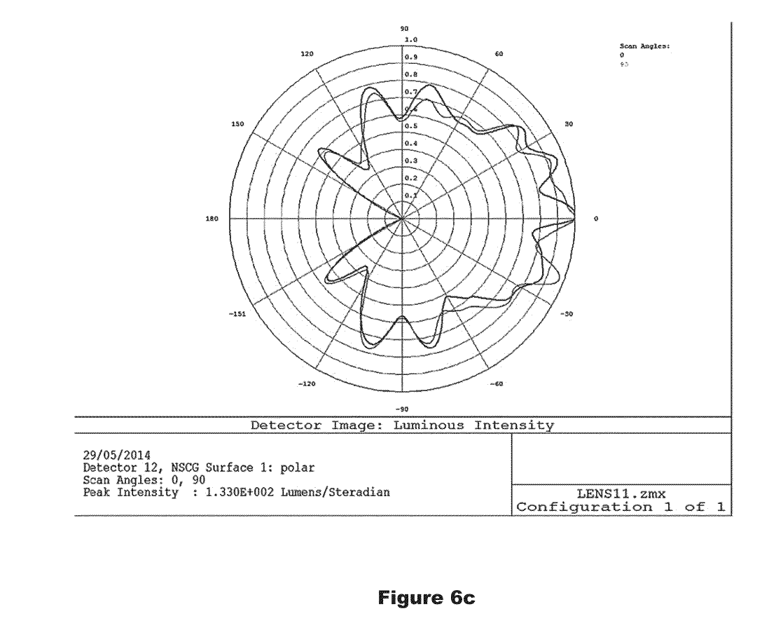

In comparison, the novel approach of separated thermal, electrical, and optical systems or components, such as shown at least in FIGS. 3-6, provides improved overall performance. FIG. 6 illustrates that thermal dissipation can occur via a candle sized heat sink 65A below the bulb or LED component 66a, which connects with the base or drip pan 63A. The LED component 66a can be any component capable of producing LED-based or type light, such as an LED chip having one or more LEDs disposed on it or other type of LED component having one or more LEDs associated with the component in some fashion. Thermal dissipation then continues via a connecting arm 5, to the main housing (6 and 7) of the lighting system or fixture 100, as shown in FIGS. 3 and 4a. The electrical system, which includes a driver 10, is separated from the light-emitting module or candle assembly 1 and located internal to the fixture 100, away from the optical system, which includes an optical distributor, a part of which is shown as a candle optic 2 in FIG. 4a. The optical system is located above the heat sink 65a and LED component to optimize the distribution of light. Because of the separation and superior thermal management of this approach, a higher power, brighter and more colorful LED component can be used that provides much more aesthetically appealing light, as described in greater detail below with respect to parameters such as lumen output, color rendering indices, gamut area indices, color temperature, color rendering, light distribution, including angular light distribution, peak brightness, glare, and spatial brightness uniformity. Additionally, since the sleeve or candle shaft 3 does not house a driver it can be relatively slim, essentially the form factor of a candle, and not a larger bulbous shape of conventional retrofit LED bulbs. This allows for the candle assembly 2 to be used within any traditional lighting fixture design without any noticeable difference aesthetically but with sufficient thermal management to support a LED light source. It also makes a retrofit process easier to perform.

In addition, by separating the thermal system from the electrical system, a less miniaturized and more sophisticated electronics system can be used, which provides for better dimming and less flicker and noise (humming), as well as the opportunity for more sophisticated controls (e.g., wireless or using sensors). This system also will have higher reliability and longevity due to cooler conditions. It makes the lighting fixture cool to the touch, below 55 degrees Celsius, which helps with both safety and longevity of components. The optical system can also be optimized as it can allow for more omnidirectional light in a smaller form factor, as no heat sink needs to surround the bulb. This enables a more compact and aesthetically pleasing optical system.

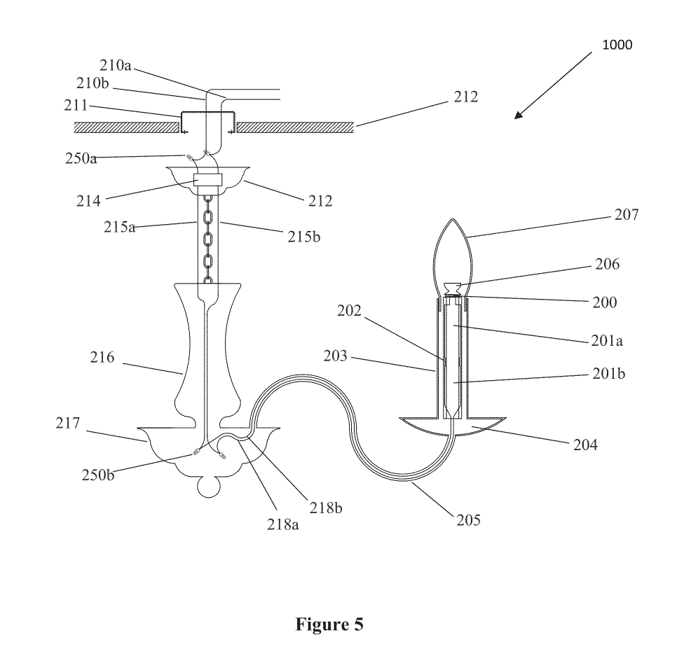

In many decorative LED lamp applications within public spaces, conventional integrated LED bulbs, such as the bulb 50 shown in FIG. 2, are susceptible to theft as the bulbs can be used in any standard screw base. Light source embodiments such as that of FIG. 5 contain a portion that is removable and replaceable, but the components are only of value in a limited selection of properly configured fixtures, thus making theft a low value proposition compared to that of an integrated LED bulb 50.

LED Driver Description:

An LED driver is a self-contained power supply that accepts input electrical power and outputs power matched to required electrical characteristics of a circuit of LEDs or LED arrays. LED drivers are often current-regulated to output a consistent direct current (DC) over a range of acceptable load voltages. Drivers may also offer dimming, for example, by means of pulse width modulation (PWM) circuits. A driver may have more than one output channel for separate control of different LEDs or LED arrays. For installed lighting applications, input power is typically alternating current (AC) from a mains source, while LEDs are powered by DC. Typically an LED driver is an integrated device containing means for voltage conversion from AC to DC and it also drives current or drive voltage regulation of LEDs of the system. It is possible though to separate voltage conversion and circuit regulation into separate components, for example with a central voltage conversion device and individual circuit regulators for individual multiple lamps.

Optical Distributor Description:

Multiple embodiments of the invention utilize a dual optical distributor system in which an outer bulb or outer optical distributor at least partially envelops, and many times fully envelops, a light distributing optic or inner optical distributor. The outer bulb can be used to change the light distribution and/or the aesthetic appearance of the lighting fixture 100. As one embodiment, a crystal bulb can be used to produce a brilliant sparkle effect. In many preferred embodiments, the inner optical distributor is configured in a form factor similar in size and shape to a candle flame or an incandescent bulb filament. In this way, an LED light source which is too bright for direct viewing can be used to supply light into a light distributing optic, which provides light of acceptable brilliance for decorative lighting applications.

Light Distributing Optic Description:

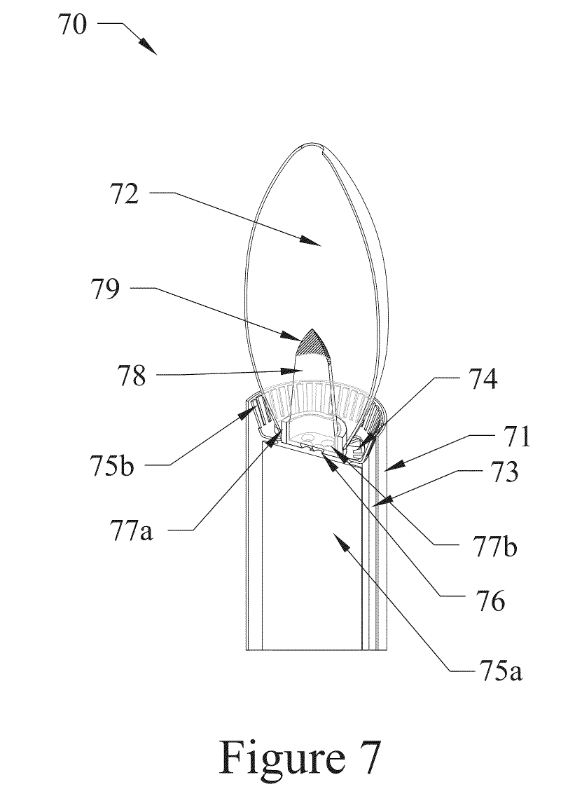

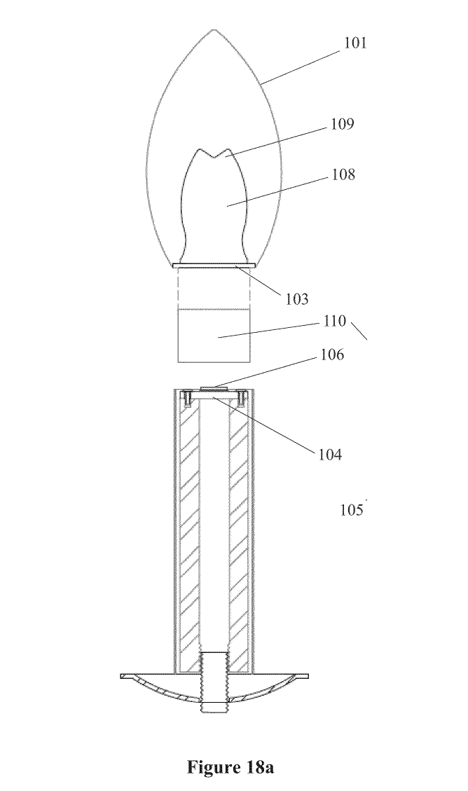

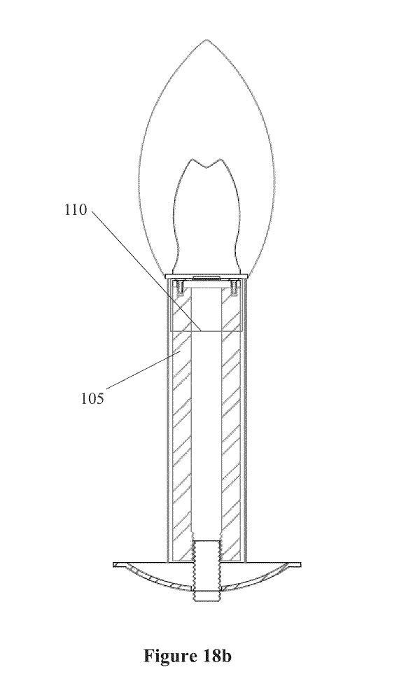

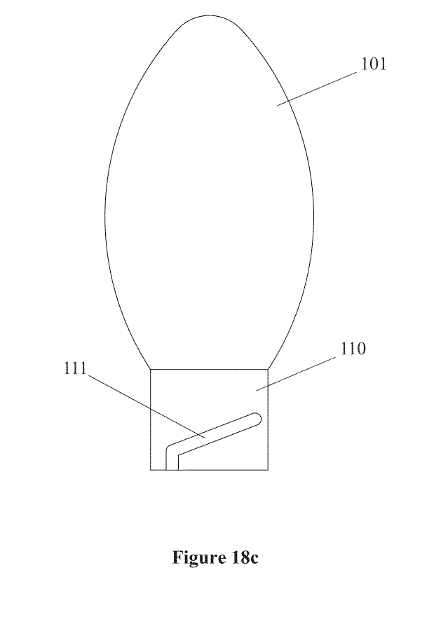

A light distributing optic is a type of optical distributor. It is a light transmissive component used to take in light from a light source and output light in a desired spatial distribution. It has one or more input faces, an internally transmitting region, and an outcoupling region where the light exits in a controlled light distribution. As means of obtaining specific desired light distribution, alternative embodiments are configured with specific features such as light guides of various shape, internal light scattering regions, and light redirecting surface features. For example, FIG. 7 contains a tapered cylindrical light guide 78 with a rounded conical tip, the tip having a light scattering region 79 which facilitates outcoupling from the optic is an smooth spatial intensity pattern. Alternatively, FIG. 18 shows a light distributing optic with a light scattering region 109 at the tip of the light guide 108 having a crater and rim type geometry. A person skilled in the art will recognize a variety of other configurations known in the art or otherwise derivable in view of the present disclosures.

In addition to controlling spatial light output directionality, a light distributing optic can be used to control the size and shape of the light emitting region. For example, in the embodiment of FIG. 7, the light output is concentrated within the tip of the light distributing optic, thereby providing a visibly bright region similar to a candle flame or incandescent filament. For this effect, typically the largest dimension of an outcoupling region is ≦ about 15 mm.

Light Outcoupling Description:

Some embodiments of the invention utilize light outcoupling regions to redirect and extract light from optical components which would otherwise be internally reflected or extracted in a misdirected light distribution. Light outcoupling regions can be used to concurrently provide desired optical distributions and reduce optical losses contributing to decreased optical efficiency. Light extracted from an optic by means of a light coupling region can be referred to as outcoupled light.

One method of providing light outcoupling is enabled within the volume of an optical component by the inclusion of dispersed particles of a particular refractive index within a matrix of differing refractive index. Stated more concisely, a volumetric light outcoupling region is comprised of dispersed particles of a refractive index n_{d} within a matrix material of refractive index nₘ wherein |n_{d}−nₘ|≧0.001. In some embodiments, described in greater detail below, multiple optically transmissive materials are used, and the difference between the refractive index nₘ of one material to the other material is approximately in the range of about 0.001 to about 0.03.

As light proceeds through the outcoupling region it is scattered and a portion of light is directed to the surface of the optical components where it exceeds the critical angle of internal reflection and is emitted from the surface. Dispersed particles may be of any geometric configurations but typical commercial additive materials are available as either round beads with smooth surfaces or imperfectly rounded particles with irregular shaped surfaces similar to grains of sand. FIG. 7 shows a light distributing optic with a light scattering region 79 which acts as a light outcoupling region. The light scattering region may be formed by coating the tip of the light guide 78 with a blend of light scattering particles dispersed within volume of light transmissive material.

Another method of providing light outcoupling is to provide light redirecting features at the output surface of an optical component. Example features include but are not limited to concise geometric shapes such as half spheres, pyramids, prisms, linear lenticulars, or any irregular pattern or texture, for example a sandblasted pattern. In these cases, the surface features provide portions of surface area where the orientation of the surface is tilted such that the critical angle required for light extraction can be exceeded by light from within the optical component that would otherwise be internally reflected or extracted in an undesired light distribution.

FIG. 3 is illustrates a decorative lighting fixture 100, as shown a chandelier, and includes some components of the present disclosure, and is intended to be generally applicable to all chandeliers, regardless of light sources used such as candles, incandescent candelabra light bulbs, or LED light sources. A light-emitting module or candle assembly 1 includes an optical distributor or candle optic 2, a sleeve or candle shaft 3, and a base or drip pan 4. The light-emitting module 1 can also be referred to as a light source assembly or light source.

As shown in FIG. 4a, the connecting arm 5 connects the candle assembly 1 with the stem 7 by means of a receiving bowl 6. The shackle 9 serves as a latch for attachment to a component for hanging the system, including but not limited to a hook, chain, cable, or cord, and can be, or can be part of, a ceiling mount that mounts the lighting fixture 100 to a ceiling.

In the illustrated embodiment, the LED driver 10 is shown located within the receiving bowl 6, but it could alternatively be located within the stem 7. Within the connecting arm 5 is a hollow channel which serves as a conduit for electrical wiring 11 to connect the driver output to the LED light source within the candle assembly 1. In this way a single LED driver 10 can be used to power multiple candle optics 2. This eliminates the need for a separate driver at each candle assembly 1. As an alternative embodiment the driver 10 can be located external to the chandelier 100 itself, for example by being placed within a ceiling above the chandelier and connected by an electrical cord 12 extending through the stem.

By separating the electrical, optical, and thermal management systems, the designs provided for herein or otherwise derivable from the present disclosures can achieve superior performance and aesthetic characteristics beyond what is available currently. The heat transfer into the candle assembly allows the LED system to run brighter and with better color characteristics than could be achieved otherwise, while maintaining a cool temperature for optimal performance and reliability. The better color characteristics, and outputted light characteristics more generally, include a large range of lumen output, a large range of color temperatures, more diverse and better color rendering capabilities, large light distributions, including angular light distribution, better peak brightness, reduced glare, and improved special brightness uniformity. Similarly, the separation of the LED driver enables the use of more sophisticated electronics to manage the dimming of the fixture and reduce annoying flicker characteristics, among other improvements. The use of the optical design in the provided for systems allows for the broad and even distribution of light while facilitating the optical thermal and electrical system. The system is optimized aesthetically, using traditional and contemporary decorative design elements without unsightly visible heat sinks characteristic of retrofit LED bulbs, or the lower aesthetics associated with less light output, lower color levels, and higher flicker levels found in previous LED designs. Prior to the present disclosure, these issues, among others, limited the penetration of LED lighting into decorative lighting systems.

FIG. 4b illustrates an alternative embodiment of an LED lighting system or fixture 100′, e.g., an LED chandelier, with a central ventilation system. Heat generated within a light-emitting module or candle assembly 1′ by an LED light source is dispersed by airflow through the candle sleeve 3′, which convects heat from heat sinks within. Air flows through the connecting arm 5′ and receiver bowl 6′, stem 7a′, fan 13′, and stem section 7b′, which serves as a ventilator. In an alternative embodiment air flowing through the connecting arm 5′ is further restricted to airflow tubing within the connecting arm 5′. Air is circulated to the outside through side vents 14a′ and top vents 14b′ in the stem 7b′. As illustrated by arrows, air is sucked into the chandelier 100′ at the candle assembly 1′ and is blown out through stem section 7b′, but the air flow direction could alternatively be reversed by flipping the fan 13′ orientation by 180 degrees. In another alternative embodiment air flow can be channeled through tubing or channels within a flow path in a manner that isolates the airflow from other internal components. In this way warm air can be diverted around temperature sensitive components such as a driver that may be located in the flow path. In further alternative embodiments the ventilator function of expelling circulated air outside of the lighting fixture can be served by other centralized locations within the lighting fixture such as the receiving bowl 6′ or other stem sections. As shown, an upper stem segment 7c′ can connect to the shackle 9′.

FIG. 5 illustrates another embodiment of an LED lighting system or fixture 1000, as shown an LED chandelier light fixture configured for mounting to a ceiling 212.

Electrical System:

AC power for the fixture 1000 is supplied by electrical mains power 210a and 210b which leads into a junction box 211 where electrical connectors 250a connect input power into the driver 214. Output direct current is transmitted by DC power lines 215a and 215b which are routed through the stem 216, receiver bowl 217, connecting arm 205, base or drip pan 204, lower heat sink 201b, and upper heat sink 201a to the LED light source 200. Inside the receiver bowl 217, electrical connectors 250b channel the driver output to power lines 218a and 218b in multiple connecting arms, each having its own LED light source. The central hub of electrical connection for the embodiment of FIG. 5 is the receiver bowl 217, but could alternatively be another portion of the chandelier 1000 with sufficiently large space such as the canopy 212, stem 216, or junction box 211. The connecting arm 205 can be substantially hollow and function as a conduit for electrical wiring, providing a pathway with enclosure, protection, and removal from sight. A large variety of series and parallel circuit are possible depending on the configuration of electrical connections, such circuits being easily determinable by a person skilled in the art in view of the present disclosure.

The driver and other auxiliary electronic control devices can be placed within the light fixture 1000 to provide a sufficiently large and relatively cool environment. In the embodiment of FIG. 5, auxiliary electronic control devices can be placed inside the canopy 212, stem 216, or receiver bowl 217, for example. In addition to a driver to regulate power to the light source electronic controls may be included for dimming, color control, wireless communication, and motion detection. Shift in Correlated Color Temperature with dimming is a particularly attractive feature in simulating the dimming of an incandescent light source. In this case a correlated color temperature shift with dimming from approximately 3000 Kelvin to about 2200 Kelvin is very desirable. The auxiliary electronic control can be wired or wireless, and can be configured to adjust any number of parameters associated with the light fixture 1000, including but not limited to a color of light produced by the one or more LEDs and an intensity of light produced by the one or more LEDs.

Optical System:

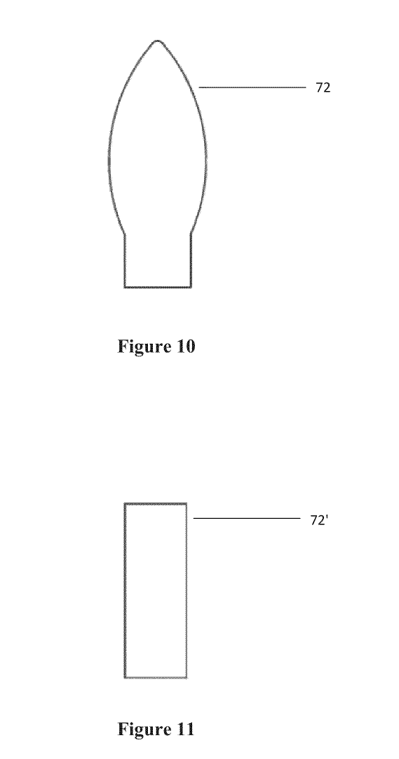

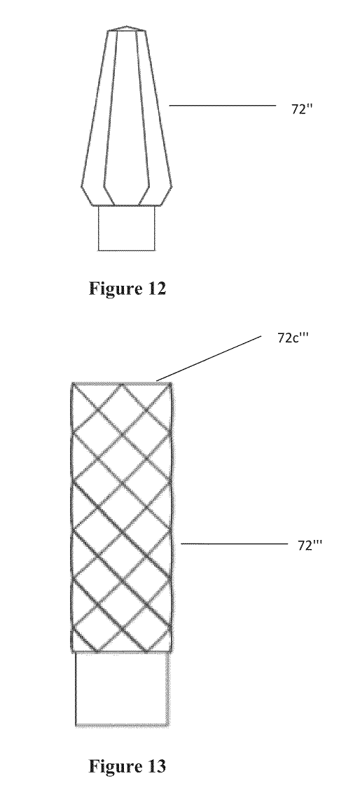

The LED light source 200 in this embodiment is a packaged chip on board LED which emits light into the refractive optic 206, which functions as an inner optical distributor, and transmits light to the bulb 207, which functions as an outer optical distributor, and transmits light into a desired spatial distribution, typically one with a predominately omnidirectional output. The bulb can be in different finishes such as faceted or smooth, frosted, or clear, and in a range of shapes such as candle, torpedo, etc. as shown by non-limiting examples of outer optical distributors 72, 72′, 72″, 72′″, and 72″″ in FIGS. 10-15. A faceted bulb 72″, 72′″, such as the bulbs shown in FIGS. 12 and 13, can produce a sparkling effect which is aesthetically attractive in many decorative applications such as chandelier and wall sconce lighting. High refractive index materials such as crystal glass can be used to intensify the effect. Notably, although in this illustrated embodiment the LED light source 200 is a packaged chip, other forms of LED lights sources can be used in conjunction with the present disclosures, and thus the present disclosure is by no means limited to just an LED chip. Any configuration capable of producing LED-based light, regardless of whether a chip is involved, can be used in conjunction with the present systems, devices, and methods.

The separation of the optical system from the thermal management system elements allows one to interchange the external optic for design flexibility and aesthetic range, as the optical envelope does not need to be sealed to the heat sink for thermal management in this design as it typically would in a retrofit bulb. This also enables different optical distribution characteristics and prismatic characteristics. For high quality of light embodiments, each LED light source would typically have lumen output approximately in the range of about 200 lumens to about 2000 lumens, color rendering index approximately in the range of about 80 to about 99, a gamut area index approximately in the range of about 60 to about 100, or more particularly in the range of about 80 to about 100, and correlated color temperature approximately in the range of about 2200 Kelvin to about 5000 Kelvin. Enhanced diming capabilities and color temperature controls are also possible. For example, color temperature can be independently controlled, or it can also be controlled in conjunction with lumen output. Accordingly, in some instance, as amount of light is dimmed by lowering a lumen output from about 100 percent to about 0.1 percent, the color temperature can be lowered in response to the lowered lumen output to decline from approximately 3000 Kelivn to about 2200 Kelvin. Typically in designed LED light sources there is a tradeoff between efficacy and color quality and higher efficacy can be achieved with lower color rendering or gamut area index values, for example embodiments of increased efficacy but a lowered gamut area index of even less than 60 are possible. Light distributions, including angular light distributions, peak brightness, reduced glare, and improved spatial brightness uniformity are other parameters of outputted light that are enhanced as a result of the present disclosures. Notably, parameters such as those mentioned above (e.g., lumen output, color rendering index of light, gamut area index, color temperature, light distributions, including angular light distributions, peak brightness, reduced glare, and improved spatial brightness uniformity), and others known to or otherwise derivable by those skilled in the art, can be achieved individually and contemporaneously with some or all of the discussed parameters.

Thermal System:

Heat from the LED light source 200 is thermally conducted into and dissipated by a series of components, including the upper heat sink 201a, the lower heat sink 201b, the base or drip pan 204, the connecting arm 205, and the receiver bowl 217. These components can all be configured to conduct, convect, and radiate heat to the surrounding air. In addition to being an ornamental feature, the base or drip pan 204 can be a thermally conductive plate which aids in thermal management. A sleeve 203 fits around the heat sink. The hollow sleeve for a candle assembly of a chandelier or wall sconce is typically in the range of about 0.5 inches to about 1.75 inches in diameter (or width) and can have the elongated form factor of a candle shape. It is significant that the range of parameters described above can be achieved in an LED module having such a small size as those found in candle assemblies and the like. The upper heat sink 201a and the lower heat sink 201b are joined by connecting pins 202 which enable a detachable upper portion of the light source assembly for removal and replacement. A person skilled in the art will recognize that other sizes and shapes beyond a candle shape or cylinder are possible for the sleeve 203.

Method of Retrofit:

The present disclosure enables existing incandescent lighting fixtures or systems to be retrofitted with LED light-emitting modules. Turning back to FIG. 5, the ceiling mount chandelier light fixture 1000 can be converted from a conventional incandescent chandelier light fixture in a retrofit process by the following steps:
1. Remove all line voltage and incandescent sockets from the lighting fixture. Attach heat sinks 201b and 201a including attached LED light source 200 to the ends of each chandelier connecting arm 205 and feed the DC power lines 215a and 215b through the connecting arms 205 to a central wiring compartment; in this embodiment the receiver bowl 217.
2. Connect wires to each connecting arm 205 in series and then connect to the driver 214 located in the canopy 213. Connect the driver 214 with the electric mains power 210a and 210b.
3. Attach the refractive optic 206 and then bulb 207 for each light source assembly.

FIG. 6a illustrates a light-emitting module or candle assembly 60a, also referred to as a light source assembly having integrated thermal management features. As shown, the LEDs 66 are mounted onto a heat sink 65 with heat sink threading 61 that allows attachment to the base or drip pan 63. The heat sink 65 is shrouded by the sleeve 62, which contains one or more ventilation slits 64 to allow air to circulate within the sleeve 62. The LEDs 66 are positioned within a reflector 67 which helps guide the light emitted from one or more LEDs 66 into the light guide 68. The light guide 68 contains a light scattering region 69 at the tip which can redirect light into a broader distribution pattern. In the illustrated embodiment, the light scattering region comprises a matrix volume of optically transmissive material containing dispersed particles of a second optically transmissive material of differing refractive index. For high forward transmission and high optical efficiency, the refractive index difference between the matrix volume of optically transmissive material and the dispersed particles of the second optically transmissive material is preferably low, for example, ≦0.03. Scattered light from such light scattering regions is found to be very efficiently transmitted, smoothly varying, and lacking undesirable sharp variations in intensity typical of conventional light redirecting optics relying on reflective optics or light redirecting microstructures using refractive scattering at an optic-air interface. Silicone is an optically transmissive matrix material which can be combined with dispersed particles of PMMA for highly efficient light scattering. Alternatively, silicone particles can also be distributed in PMMA or urethane for similar high transmission and forward scattering. To achieve higher scattering angles, addition of some particles with a higher refractive index difference between the matrix and dispersed particles can be utilized. To achieve more widespread light distribution, reflective particles which are not optically transmissive can optionally be added to the scattering region 69. Examples of reflective particles include those made from titanium dioxide or boron nitride. Additional light scattering can optionally be added by used of surface micro-features, for example half spheres, pyramids, prisms, and lenticular patterns.

FIG. 6b provides for another light-emitting module or candle assembly 60b having integrated thermal management features. It has versions of the same numbered components as FIG. 6a, and thus a broader discussion of the components is unnecessary. A person skilled in the art can review the candle assembly 60b and understand its features, and relevant differences between it and the candle assembly 60a of FIG. 60a. By way of non-limiting examples, the candle assembly 60b has a differently shaped inner optical distributor, and also illustrates a connecting of the outer optical distributor to the heat sink by way of a mechanical connection, as shown opposed screws 55b. A person skilled in the art will recognize that each of the outer and inner optical distributors can be coupled to at least one of the heat sink and the sleeve by any number of techniques known by those skilled in the art for connecting two elements, whether mechanical or otherwise, including but not limited to male-female connections, screws, adhesives, and other bonding elements.

FIG. 6c is a plot of Measured Optical Intensity vs. Angle for an embodiment of a candle assembly similar to that illustrated in FIG. 6b and comprising a white LED light source. The zero orientation represents the optical axis of the candle assembly, aligned with the shaft in this embodiment. The plot shows a relatively even distribution of light intensity from zero degrees to about 140 degrees and from zero degrees to about −140 degrees.

FIG. 7 illustrates an embodiment of a candle assembly 70 similar to FIG. 6a but further detailing features near the LED 76 light sources. In this embodiment an upper heat sink 75b complements the lower heat sink 75a by removing heat from the output face of the circuit board 74. Reflectors 77b gather and direct light from individual LEDs 76 while reflector 77a gathers and directs light from the LEDs 76. All reflectors can be integrated into a single part molded from silicone containing reflective particles such as titanium dioxide. Light from the LED 76 propagates through an inner optical distributor, and more particularly through the light guide 78 and light scattering region 79 in the illustrated embodiment of an inner optical distributor. An air gap 73 impedes heat transfer to the sleeve 71. An outer optical distributor, bulb 72, surrounds the light guide 78. An optical distributor more generally can be either the inner or outer distributor alone, or the combination of the two together (or the combination of more than two in embodiments that include more than two optical distributors).

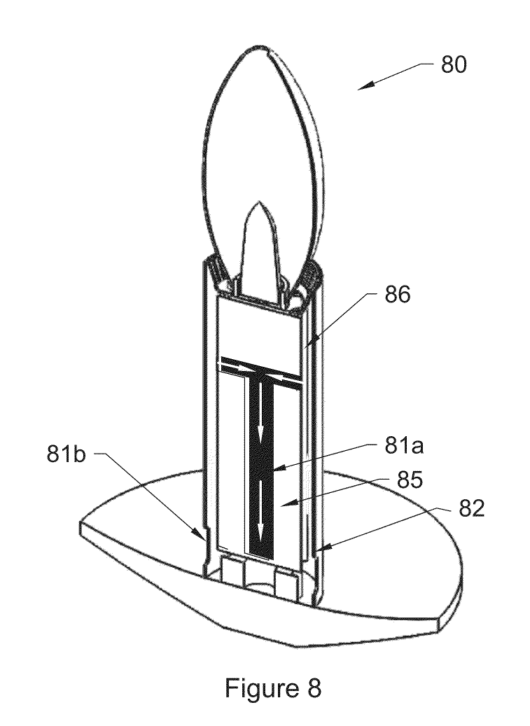

FIG. 8 is a light-emitting module or candle assembly 80 containing air passages for use in an active air circulation system. There are air channels 81a within the heat sink 85 as well as between the heat sink 85 and sleeve 81b which allow for circulation of air and convective cooling in combination with the vents 82 in the sleeve 86.

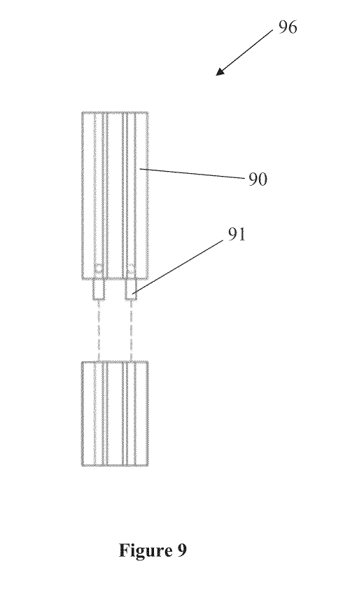

FIG. 9 shows a candle shaft or sleeve 96 having a heat sink 90 and a bin-pin connector 91 for easy connect and disconnect. The bin-pin connector 91 allows for easy replacement of the light source without replacing the entire candle assembly.

FIG. 10-FIG. 15 illustrate various embodiments of outer optical distributors or envelopes which can be used to cover and redirect light output of LED light sources and/or the inner optical distributor, thus performing functions of optic and/or outer bulb components. Dimensions will vary by particular embodiment but will range in size from a smaller component slightly larger than a light source to a larger component functioning as an enlarged outer bulb or luminaire outer lens. A wide variety of materials can be used to form the outer and inner optical distributors, or portions thereof (e.g., the light guide of the inner optical distributor), including but not limited to glass (e.g., crystal glass, K-5 glass, and K-9 glass), acrylic, silicone, polyurethane, polycarbonate, and cyclic olefin copolymer. The same or different materials can be used in the outer and inner optical distributors, and more than one material can be used for one or both distributors.

FIG. 10 illustrates an outer optical distributor 72 having a Bulb Shape Hollow Glass Envelope.

FIG. 11 illustrates an outer optical distributor 72′ having a Hollow Glass Tube Envelope.

FIG. 12 illustrates an outer optical distributor 72″ including a K-5 or K-9 grade cut solid crystal light guide and light scattering optic, wherein a light source would be located within the center cavity. Due to high dispersion values, K-5 and K-9 crystal is particularly effective for creating color effects, commonly referred to as “fire” in gemology nomenclature. Dispersion is a material property representing the difference in the refractive index of a material at the B and G (686.7 nm and 430.8 nm) or C and F (656.3 nm and 486.1 nm) Fraunhofer wavelengths.

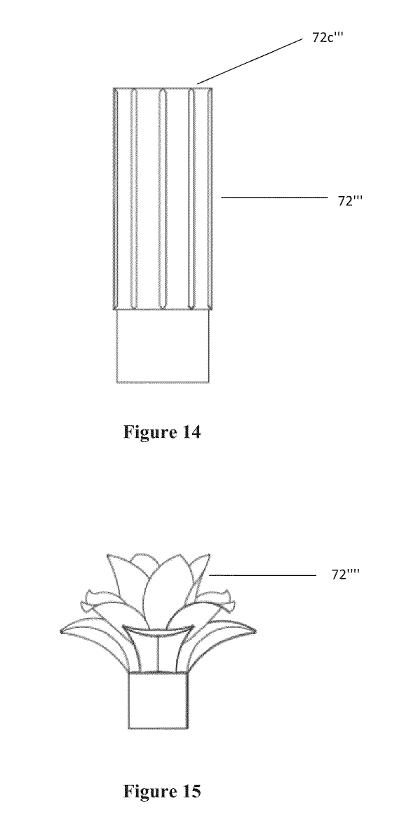

FIGS. 13 and 14 illustrate an outer optical distributor 72′″ having a hollow glass envelope with closed end 72c′″.

FIG. 15 illustrates an outer optical distributor 72″ having a Flower Pedal Light Guide/Diffuser.

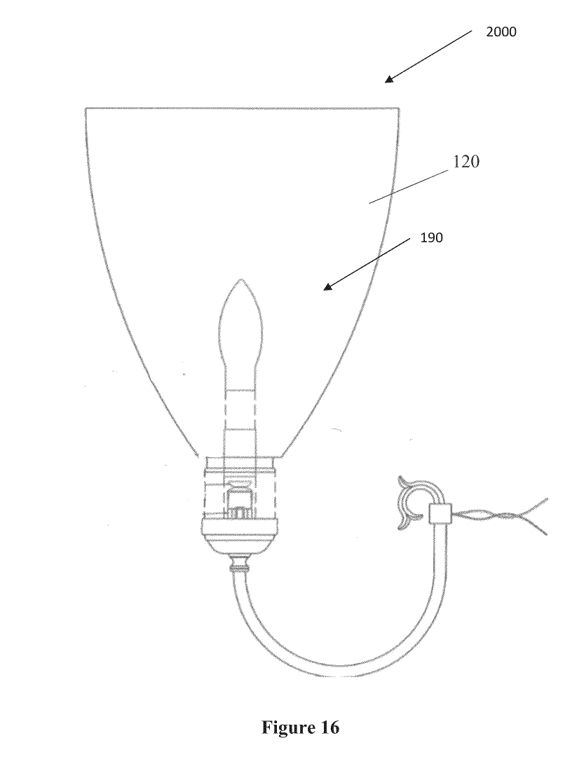

FIG. 16 is illustrates a wall sconce 2000 in which an LED light source assembly 190 is positioned within an outer optical diffuser or shade 120 in the form of a light diffusing glass goblet. The shade 120 acts to diffuse light, reduce peak brightness, and provide an aesthetic effect It provides a full color, warm, and omnidirectional lighting pattern that could be used in a hallway or bathroom, for example.

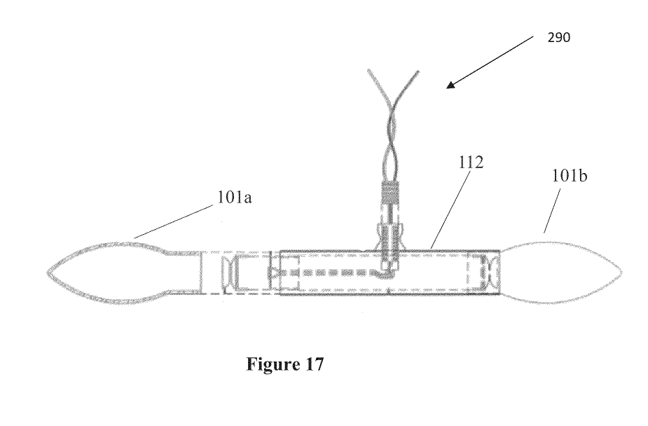

FIG. 17 is a double ended light-emitting module or candle assembly. In this embodiment, two outer optical distributors or bulbs, 101a and 101b, are mounted extending from opposing ends of the same sleeve or candle shaft 112.

FIG. 18a (separated components) and FIG. 18b (assembled components) illustrate one exemplary embodiment of a candle assembly process. An inner optical distributor that includes a light guide 108 and a light scattering region 109 is inserted inside an outer optical distributor or bulb 101, after which the neck 110 is fused with the flange 103 of the light guide to produce an integrated optic, sometimes referred to as an optical distributor, which is slid over the heat sink 105 and circuit board 104 to position the light guide 108 to receive light from the LED 106. In this way a light guide 108 which can be physically slid inside the outer bulb 101 but not through the neck 110 can be assembled and mounted in position. Alternatively, if the flange of the light guide is comprised of a flexible material, for example silicone, it can be pressed through a neck of smaller diameter than the flange and then expanded to full shape inside the bulb. In this way the outer bulb and neck can be fabricated as a single unit into which the light guide is inserted. As illustrated the flange 103 has the shape of a flat ring but further embodiments could modify the shape, for example to comprise angled or barbed shapes which ease inserting thru the neck and then expand inside the bulb to press against the outer bulb wall.

FIG. 18c provides for an optical distributor or optic with means for twist lock connection. The optic includes an outer optical distributor or bulb 101 with neck 110 wherein the neck contains a raised, recessed, or slit groove 111 that when combined with a complementary feature in a sleeve or other light-emitting module or candle assembly component provides a means for tightening the outer optic in place with a twisting motion.

Having thus described several aspects of at least one embodiment of this invention, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

Further, the following subject matter is identifiable or derivable from the disclosures provided for herein:

1. A lighting fixture, comprising:

a housing having an LED driver disposed therein;

a light-emitting module having an elongate sleeve with a heat sink disposed therein, an LED component configured to produce light by way of one or more LEDs associated therewith, the LED component being coupled to a top end of the heat sink, and at least one optical distributor disposed above the LED component and above at least a portion of the sleeve, the at least one optical distributor being coupled to at least one of the heat sink and the sleeve, and the heat sink being conductively coupled to the housing; and

a connecting arm extending between the housing and the light-emitting module, the connecting arm including a conduit having a wire disposed therein, the wire electrically coupling the LED driver to the light-emitting module such that the LED driver provides electrical current to produce light by way of the one or more LEDs,

wherein the conductive coupling between the heat sink and the housing is such that heat generated by the LED component is dissipated through the heat sink and through the housing.

2. The lighting fixture of number 1, wherein the elongate sleeve has a diameter approximately in the range of about 0.5 inches to about 1.75 inches.
3. The lighting fixture of number 2, wherein a lumen output produced by the one or more LEDs is approximately in the range of about 200 lumens to about 2000 lumens.
4. The lighting fixture of number 3, wherein a color rendering index of light produced by the one or more LEDs is approximately in the range of about 80 to about 99.
5. The lighting fixture of number 4, wherein a gamut area index of light produced by the one or more LEDs is approximately in the range of about 60 to about 100.
6. The lighting fixture of number 3, wherein a color temperature produced by the one or more LEDs is approximately in the range of about 2200 Kelvin to about 5000 Kelvin.
7. The lighting fixture of number 3, wherein the lumen output produced by the one or more LEDs is configured to be dimmed such that as the lumen output is lowered from about 100 percent to about 0.1 percent, a color temperature produced by the one or more LEDs goes from approximately 3000 Kelvin to about 2200 Kelvin.
8. The lighting fixture of number 1, wherein the at least one optical distributor comprises:

an outer optical distributor being removably and replaceably coupled to at least one of the heat sink and the sleeve; and

an inner optical distributor disposed within the outer optical distributor, the inner optical distributor having a light scattering region configured to redirect light into a broad distribution pattern, towards the outer optical distributor.

9. The lighting fixture of number 8, wherein the inner optical distributor further comprises a light guide disposed between the LED component and the light scattering region, the light guide being configured to guide light from the one or more LEDs to the light scattering region.
10. The lighting fixture of number 1, further comprising:

a plurality of the light-emitting modules; and

a plurality of the connecting arms, each connecting arm having a wire disposed therein,

wherein each light-emitting module of the plurality of light-emitting modules has a connecting arm of the plurality of connecting arms associated therewith to connect the light-emitting module to the housing, and each wire disposed in the respective connecting arms provides electrical current from the LED driver to one or more LEDs of each of the light-emitting modules to produce light from the one or more LEDs of the respective light-emitting modules.

11. The lighting fixture of number 10, wherein the housing further comprises:

a ceiling mount configured to mount the lighting fixture to a ceiling;

a central hub disposed below the ceiling mount, wherein the plurality of connecting arms couple to the housing at the central hub; and

a stem disposed between the ceiling and the central hub to allow the central hub, the plurality of connecting arms, and the plurality of light-emitting modules to be disposed a distance away from a ceiling,

wherein the LED driver is disposed in the central hub.

12. The lighting fixture of number 10, wherein the housing further comprises:

a ceiling mount configured to mount the lighting fixture to a ceiling;

a central hub disposed below the ceiling mount, wherein the plurality of connecting arms couple to the housing at the central hub; and

a stem disposed between the ceiling and the central hub to allow the central hub, the plurality of connecting arms, and the plurality of light-emitting modules to be disposed a distance away from a ceiling,

wherein the LED driver is disposed in the stem.

13. The lighting fixture of number 12, wherein the stem comprises one or more ventilation slits formed therein.
14. The lighting fixture of number 1, wherein the sleeve comprises one or more ventilation slits formed therein.
15. The lighting fixture of number 1, wherein the light-emitting module further comprises a conductive plate disposed between the heat sink and the connecting arm to conductively couple the heat sink to the connecting arm and to the housing.
16. The lighting fixture of number 1, further comprising an auxiliary electronic control coupled to the LED component, the control being configured to adjust at least one of: a color of light produced by the one or more LEDs, and an intensity of light produced by the one or more LEDs.
17. A light source assembly, comprising:

a hollow sleeve;

a heat sink disposed within the hollow sleeve;

a base disposed at a bottom end of the hollow sleeve, the heat sink being conductively coupled with the base;

an LED component disposed on top of the heat sink, the LED component including one or more LEDs associated therewith that are configured to produce light;

an outer optical distributor removably and replaceably coupled to at least one of the heat sink and the hollow sleeve; and

an inner optical distributor disposed within the outer optical distributor, the inner optical distributor having a light scattering region configured to redirect light produced by the one or more LEDs into a broad distribution pattern, toward the outer optical distributor,

wherein the outer optical distributor can be uncoupled from the heat sink and/or the hollow sleeve such that another outer optical distributor can be coupled to the at least one of the heat sink and the hollow sleeve in the same manner the first outer optical distributor was coupled to at least one of the heat sink and the hollow sleeve.

18. The light source assembly of number 17, wherein the outer optical distributor comprises crystal.
19. The light source assembly of number 18, wherein the crystal is faceted.
20. The light source assembly of number 17, wherein the outer optical distributor includes a body having at least one opening formed therein through which light from the LED component passes.
21. The light source assembly of number 17, wherein the outer optical distributor includes a body that covers any portion of a surrounding region disposed adjacent to the inner optical distributor through which light from the LED component passes.
22. The light source assembly of number 17, wherein the hollow sleeve has a diameter approximately in the range of about 0.5 inches to about 1.75 inches.
23. The light source assembly of number 22, wherein a lumen output produced by the one or more LEDs is approximately in the range of about 200 lumens to about 2000 lumens.
24. The light source assembly of number 23, wherein a color rendering index of light produced by the one or more LEDs is approximately in the range of about 80 to about 99.
25. The light source assembly of number 24, wherein a gamut area index of light produced by the one or more LEDs is approximately in the range of about 60 to about 100.
26. The light source assembly of number 23, wherein a color temperature produced by the one or more LEDs is approximately in the range of about 2200 Kelvin to about 5000 Kelvin.
27. The light source assembly of number 23, wherein the lumen output produced by the one or more LEDs is configured to be dimmed such that as the lumen output is lowered from about 100 percent to about 0.1 percent, a color temperature produced by the one or more LEDs goes from approximately 3000 Kelvin to about 2200 Kelvin.
28. The light source assembly of number 17, wherein the light scattering region comprises a matrix volume of a first optically transmissive material having dispersed particles of a second optically transmissive material, the first and second optically transmissive materials having different refractive indices.
29. The light source assembly of number 28, wherein the difference between the refractive indices of the first and second optically transmissive materials is approximately in the range of about 0.001 to about 0.03.
30. The light source assembly of number 17, wherein an entirety of the heat sink is disposed within the hollow sleeve.
31. The light source assembly of number 17, further comprising a second heat sink disposed in the hollow sleeve above the first heat sink, the second heat sink encircling portions of both the outer and inner optical distributors.
32. The light source assembly of number 17, wherein the hollow sleeve comprises one or more ventilation slits formed therein.
33. The light source assembly of number 17, wherein a width of the base is larger than a diameter of the hollow sleeve.
34. The light source assembly of number 17, further comprising an auxiliary electronic control coupled to the LED component, the control being configured to adjust at least one of: a color of light produced by the one or more LEDs, and an intensity of light produced by the one or more LEDs.
35. A method for replacing a light source, comprising:

removing one or more existing incandescent sockets and line voltage associated therewith from a lighting fixture, the lighting fixture comprising a housing, at least one existing incandescent light module disposed about the housing, each incandescent light module of the at least one existing incandescent light modules having a sleeve and an incandescent socket of the one or more existing incandescent sockets associated therewith, and a connecting arm extending between each of the incandescent light modules and the housing;

attaching a heat sink having one or more LEDs coupled thereto to the connecting arm at one or more locations of the lighting fixture at which an incandescent socket of the one or more existing incandescent sockets was previously disposed, the heat sink being disposed in at least a portion of the sleeve;

disposing one or more direct current power lines that are electrically coupled to the one or more LEDs through a conduit of the connecting arm to a central wiring compartment of the housing;

disposing an LED driver within the housing;

electrically coupling the one or more direct current power lines to the LED driver;

electrically coupling the LED driver to electric mains power associated with the lighting fixture; and

coupling an optical distributor to at least one of the heat sink and the sleeve.

36. The method of number 35, wherein the optical distributor includes an inner optical distributor and an outer optical distributor, and wherein coupling an optical distributor to at least one of the heat sink and the sleeve further comprises:

coupling the inner optical distributor to the heat sink; and

coupling the outer optical distributor to the sleeve.

37. The method of number 36, wherein the optical distributor is removable and replaceable, the method further comprising:

uncoupling the outer optical distributor from the sleeve; and

coupling a second outer optical distributor to the sleeve.

38. The method of number 35, wherein heat dissipates through the heat sink, through the connecting arm, and through the housing based on the heat sink being conductively coupled to the housing by way of the connecting arm.
39. The method of number 35, wherein the one or more LEDs are configured to be dimmed to adjust an intensity of light produced by the one or more LEDs.
40. The method of number 35, wherein the one or more LEDS are configured to be color adjusted to adjust a color of light produced by the one or more LEDs.
41. The method of number 35, wherein the lighting fixture is a chandelier.
42. The method of number 35, wherein the sleeve has a diameter approximately in the range of about 0.5 inches to about 1.75 inches.
43. The method of number 42, wherein a lumen output produced by the one or more LEDs is approximately in the range of about 200 lumens to about 2000 lumens.
44. The method of number 43, wherein a color rendering index of light produced by the one or more LEDs is approximately in the range of about 80 to about 99.
45. The method of number 44, wherein a gamut area index of light produced by the one or more LEDs is approximately in the range of about 60 to about 100.
46. The method of number 43, wherein a color temperature produced by the one or more LEDs is approximately in the range of about 2200 Kelvin to about 5000 Kelvin.
47. The method of number 43, wherein the lumen output produced by the one or more LEDs is configured to be dimmed such that as the lumen output is lowered from about 100 percent to about 0.1 percent, a color temperature produced by the one or more LEDs goes from approximately 3000 Kelvin to about 2200 Kelvin.

### LIST OF NUMERICAL REFERENCES

1 and 1′—Light-Emitting Module or Candle Assembly
2 and 2′—Optical Distributor or Candle Optic
3 and 3′—Sleeve or Candle Shaft
4 and 4′—Base or Drip Pan
5 and 5′—Connecting arm
6 and 6′—Receiver Bowl
7—Stem
7a′—Stem (airflow manifold)
7b′—Stem (ventilator)
7c′—Stem (upper)
9 and 9′—Shackle
10—Driver
11—Electrical wiring
12—Electrical cord
13—Fan
14a—Side Vent
14b—Top Vent
41—Candle assembly
42—Candle Shaft
43—Drip Pan
44—Bulb
45—Incandescent filament
50—LED light bulbs
51—Screw Base
52—Housing
53—Optic
54—Outer Bulb
55b—Screws
60a and 60b—Light-Emitting Module or Candle Assembly
61a and 61b—Heat sink threading
62a and 62b—Sleeve
63a and 63b—Base or Drip Pan
64a and 64b—Ventilation slit
65a and 65b—Heat sink
66a and 66b—bulb or LED
67a and 67b—Reflector
68a and 68b—Light guide
69a and 69b—Light scattering region
70—Light-Emitting Module or Candle Assembly
71—Sleeve
72 and 72′ and 72″ and 72′″ and 72″″—Outer Optical Distributor or Outer bulb
73—Air gap
74—Circuit board
75a—Lower heat sink
75b—Upper heat sink
76—LED
77a—Reflector
77b—Reflector
78—Light guide (part of an Inner Optical Distributor)
79—Light scattering region (part of an Inner Optical Distributor)
80—Light-Emitting Module or Candle Assembly
81a—air channel (inside heat sink)
81b—air channel (outside heat sink)
82—sleeve vent
85—Heat Sink
86—Sleeve
90—Heat Sink
91—Pin
96—Candle Shaft or Sleeve
100 and 100′—Lighting Fixture
101a and 101b—Outer Optical Distributors or Outer bulbs
103—Flange
104—Circuit board
105—Heat Sink
106—LED
108—Light guide (part of Inner Optical Distributor)
109—Light scattering region (part of Inner Optical Distributor)
110—Neck
111—Groove
112—Sleeve or Candle shaft
120—Shade
190—LED Light Source Assembly
200—LED Light Source
201a—Upper Heat Sink
201b—Lower Heat Sink
202—Heat sink connecting pin
203—Sleeve
204—Base or Drip Pan
205—Connecting arm
206—Refractive Optic
207—Bulb
210a—Electric Mains Power
210b—Electric Mains Power
211—Junction Box
212—Ceiling
213—Canopy
214—Driver
215a—DC Power Line
215b—DC Power Line
216—Stem
217—Receiver bowl
218a—Light source power line
218b—Light source power line
250a—Electrical Connector
250b—Electrical Connector
1000—Lighting Fixture (Chandelier)
2000—Lighting Fixture (Wall Sconce)

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A lighting fixture, comprising:
a housing having an LED driver disposed therein;
a light-emitting module having an elongate sleeve with a heat sink disposed therein, an LED component configured to produce light by way of one or more LEDs associated therewith, the LED component being coupled to a top end of the heat sink, and at least one optical distributor disposed above the LED component and above at least a portion of the sleeve, the at least one optical distributor being coupled to at least one of the heat sink and the sleeve, and the heat sink being conductively coupled to the housing; and
a connecting arm extending between the housing and the light-emitting module, the connecting arm including a conduit having a wire disposed therein, the wire electrically coupling the LED driver to the light-emitting module such that the LED driver provides electrical current to produce light by way of the one or more LEDs,
wherein the conductive coupling between the heat sink and the housing is such that heat generated by the LED component is dissipated through the heat sink and through the housing.

2. The lighting fixture of claim 1, wherein the elongate sleeve has a diameter approximately in the range of about 0.5 inches to about 1.75 inches.

3. The lighting fixture of claim 2, wherein a lumen output produced by the one or more LEDs is approximately in the range of about 200 lumens to about 2000 lumens.

4. The lighting fixture of claim 3, wherein a color rendering index of light produced by the one or more LEDs is approximately in the range of about 80 to about 99.

5. The lighting fixture of claim 4, wherein a gamut area index of light produced by the one or more LEDs is approximately in the range of about 60 to about 100.

6. The lighting fixture of claim 3, wherein a color temperature produced by the one or more LEDs is approximately in the range of about 2200 Kelvin to about 5000 Kelvin.

7. The lighting fixture of claim 3, wherein the lumen output produced by the one or more LEDs is configured to be dimmed such that as the lumen output is lowered from about 100 percent to about 0.1 percent, a color temperature produced by the one or more LEDs goes from approximately 3000 Kelvin to about 2200 Kelvin.

8. The lighting fixture of claim 1, wherein the at least one optical distributor comprises:
an outer optical distributor being removably and replaceably coupled to at least one of the heat sink and the sleeve; and
an inner optical distributor disposed within the outer optical distributor, the inner optical distributor having a light scattering region configured to redirect light into a broad distribution pattern, towards the outer optical distributor.

9. The lighting fixture of claim 8, wherein the inner optical distributor further comprises a light guide disposed between the LED component and the light scattering region, the light guide being configured to guide light from the one or more LEDs to the light scattering region.

10. The lighting fixture of claim 1, further comprising:
a plurality of the light-emitting modules; and
a plurality of the connecting arms, each connecting arm having a wire disposed therein,
wherein each light-emitting module of the plurality of light-emitting modules has a connecting arm of the plurality of connecting arms associated therewith to connect the light-emitting module to the housing, and each wire disposed in the respective connecting arms provides electrical current from the LED driver to one or more LEDs of each of the light-emitting modules to produce light from the one or more LEDs of the respective light-emitting modules.

11. The lighting fixture of claim 10, wherein the housing further comprises:
a ceiling mount configured to mount the lighting fixture to a ceiling;
a central hub disposed below the ceiling mount, wherein the plurality of connecting arms couple to the housing at the central hub; and
a stem disposed between the ceiling and the central hub to allow the central hub, the plurality of connecting arms, and the plurality of light-emitting modules to be disposed a distance away from a ceiling,
wherein the LED driver is disposed in the central hub.

12. The lighting fixture of claim 10, wherein the housing further comprises:
a ceiling mount configured to mount the lighting fixture to a ceiling;
a central hub disposed below the ceiling mount, wherein the plurality of connecting arms couple to the housing at the central hub; and
a stem disposed between the ceiling and the central hub to allow the central hub, the plurality of connecting arms, and the plurality of light-emitting modules to be disposed a distance away from a ceiling,
wherein the LED driver is disposed in the stem.

13. The lighting fixture of claim 1, wherein the light-emitting module further comprises a conductive plate disposed between the heat sink and the connecting arm to conductively couple the heat sink to the connecting arm and to the housing.

14. The lighting fixture of claim 1, further comprising an auxiliary electronic control coupled to the LED component, the control being configured to adjust at least one of: a color of light produced by the one or more LEDs, and an intensity of light produced by the one or more LEDs.

15. A light source assembly, comprising:
a hollow sleeve;
a heat sink disposed within the hollow sleeve;
a base disposed at a bottom end of the hollow sleeve, the heat sink being conductively coupled with the base;
an LED component disposed on top of the heat sink, the LED component including one or more LEDs associated therewith that are configured to produce light;
an outer optical distributor removably and replaceably coupled to at least one of the heat sink and the hollow sleeve; and
an inner optical distributor disposed within the outer optical distributor, the inner optical distributor having a light scattering region configured to redirect light produced by the one or more LEDs into a broad distribution pattern, toward the outer optical distributor,
wherein the outer optical distributor can be uncoupled from the heat sink and/or the hollow sleeve such that another outer optical distributor can be coupled to the at least one of the heat sink and the hollow sleeve in the same manner the first outer optical distributor was coupled to at least one of the heat sink and the hollow sleeve.

16. The light source assembly of claim 15, wherein the outer optical distributor comprises crystal.

17. The light source assembly of claim 16, wherein the crystal is faceted.

18. The light source assembly of claim 15, wherein the outer optical distributor includes a body having at least one opening formed therein through which light from the LED component passes.

19. The light source assembly of claim 15, wherein the outer optical distributor includes a body that covers any portion of a surrounding region disposed adjacent to the inner optical distributor through which light from the LED component passes.

20. The light source assembly of claim 15, wherein the hollow sleeve has a diameter approximately in the range of about 0.5 inches to about 1.75 inches.

21. The light source assembly of claim 20, wherein a lumen output produced by the one or more LEDs is approximately in the range of about 200 lumens to about 2000 lumens.

22. The light source assembly of claim 21, wherein a color rendering index of light produced by the one or more LEDs is approximately in the range of about 80 to about 99.

23. The light source assembly of claim 22, wherein a gamut area index of light produced by the one or more LEDs is approximately in the range of about 60 to about 100.

24. The light source assembly of claim 21, wherein a color temperature produced by the one or more LEDs is approximately in the range of about 2200 Kelvin to about 5000 Kelvin.

25. The light source assembly of claim 21, wherein the lumen output produced by the one or more LEDs is configured to be dimmed such that as the lumen output is lowered from about 100 percent to about 0.1 percent, a color temperature produced by the one or more LEDs goes from approximately 3000 Kelvin to about 2200 Kelvin.

26. The light source assembly of claim 15, wherein the light scattering region comprises a matrix volume of a first optically transmissive material having dispersed particles of a second optically transmissive material, the first and second optically transmissive materials having different refractive indices.

27. The light source assembly of claim 26, wherein the difference between the refractive indices of the first and second optically transmissive materials is approximately in the range of about 0.001 to about 0.03.

28. The light source assembly of claim 15, wherein an entirety of the heat sink is disposed within the hollow sleeve.

29. The light source assembly of claim 15, wherein a width of the base is larger than a diameter of the hollow sleeve.

30. The light source assembly of claim 15, further comprising an auxiliary electronic control coupled to the LED component, the control being configured to adjust at least one of: a color of light produced by the one or more LEDs, and an intensity of light produced by the one or more LEDs.
